(19) United States
(12) Patent Application Publication
(10) Pub. No.: US 2025/0324171 A1
(43) Pub. Date: Oct. 16, 2025

(54) PHOTOELECTRIC CONVERSION DEVICE AND EQUIPMENT

(71) Applicant: CANON KABUSHIKI KAISHA, Tokyo (JP)

(72) Inventors: YU ARISHIMA, Kanagawa (JP); TAKANORI YAMASHITA, Tokyo (JP); DAISUKE KOBAYASHI, Kanagawa (JP)

(21) Appl. No.: 19/176,302

(22) Filed: Apr. 11, 2025

(30) Foreign Application Priority Data
Apr. 15, 2024 (JP) 2024-065615
Jul. 29, 2024 (JP) 2024-122556

(51) Int. Cl. H04N 25/709; H04N 25/78; H10F 39/00

(52) U.S. Cl. CPC H04N 25/709; H04N 25/78; H10F 39/809

(57) ABSTRACT

Photoelectric conversion device includes first block of pixels, that is controlled as a block to perform in-pixel readout operation in a predetermined period, second block of pixels, that is controlled as a block to perform in-pixel readout operation in a period after the predetermined period, and third block different from the first and second blocks. In the predetermined period, amount of current flowing through current source in the third block is smaller than amount of current flowing through current source in the first block and amount of current flowing through current source in the second block. In the predetermined period, amount of current flowing through current source in the second block is not more than amount of current flowing through current source in the first block.

### BACKGROUND OF THE INVENTION

### Field of the Invention

The present invention relates to a photoelectric conversion device and equipment.

### Description of the Related Art

Japanese Patent Laid-Open No. 2022-51548 and International Publication No. 2016/009832 describe a global shutter type CMOS image sensor in which each pixel includes a memory for holding a signal. In the global shutter method, a charge accumulation operation starts and ends simultaneously in all pixels.

However, in the global shutter type CMOS image sensor, since an operation of writing, in the memory, a signal corresponding to charges accumulated in a photoelectric conversion element is performed simultaneously in all pixels, the peak value of current consumption in a pixel array can be significantly large. Therefore, a power supply circuit and a power supply line that assume such a peak value are required.

### SUMMARY OF THE INVENTION

The present invention provides a technique advantageous in suppressing the peak value of current consumption in a pixel array.

One of aspects of the present invention provides a photoelectric conversion device that includes a plurality of pixels arranged to form a plurality of rows and a plurality of columns, the device comprising a controller configured to control the plurality of pixels divided into a plurality of blocks, wherein each of the plurality of blocks includes pixels arranged in the same row and pixels arranged in different rows, each pixel includes a photoelectric conversion element, and an in-pixel readout unit configured to perform an in-pixel readout operation of reading out and holding a signal from the photoelectric conversion element, the in-pixel readout unit includes a source follower circuit including an amplification transistor and a current source, the controller controls the plurality of pixels such that a period during which the in-pixel readout unit of each of the plurality of pixels performs the in-pixel readout operation is the same within each individual block and different between the plurality of blocks, the plurality of blocks include a first block that is controlled as a block to perform the in-pixel readout operation by the controller in a predetermined period, a second block that is controlled as a block to perform the in-pixel readout operation by the controller in a period after the predetermined period, and a third block different from the first block and the second block, in the predetermined period, an amount of current flowing through the current source in the third block is smaller than an amount of current flowing through the current source in the first block and an amount of current flowing through the current source in the second block, and in the predetermined period, an amount of current flowing through the current source in the second block is not more than an amount of current flowing through the current source in the first block.

Further features of the present invention will become apparent from the following description of exemplary embodiments with reference to the attached drawings.

### BRIEF DESCRIPTION OF THE DRAWINGS

FIG. 1 is a block diagram showing the arrangement of a photoelectric conversion device according to the first embodiment;

FIG. 2 is a view exemplarily showing the circuit arrangement of one pixel and the circuit arrangement in one column of the photoelectric conversion device according to the first embodiment;

FIGS. 3A and 3B are views exemplarily showing a global shutter operation and a partial global shutter operation, respectively;

FIG. 4 is a timing chart exemplarily showing a readout operation of signals in the pixel;

FIG. 5 is a timing chart exemplarily showing a readout operation of signals from a pixel array;

FIG. 6 is a view showing an example of dividing the pixel array in the first embodiment;

FIG. 7 is a view showing an example of a method of driving a plurality of blocks in the first embodiment;

FIG. 8 is a view showing a modification of the circuit arrangement of the pixel;

FIG. 9 is a timing chart exemplarily showing a readout operation of signals in the pixel shown in FIG. 8;

FIG. 10 is a timing chart exemplarily showing a readout operation of signals from the pixel array constituted by the pixel shown in FIG. 8;

FIG. 11A is a view showing an example of a method of driving a plurality of blocks in the second embodiment;

FIG. 11B is a view showing an example of the method of driving the plurality of blocks in the second embodiment;

FIG. 12 is a view showing an example of a method of driving a plurality of blocks in the third embodiment;

FIG. 13 is a block diagram showing the arrangement of a portion of a photoelectric conversion device according to the third embodiment;

FIG. 14 is a view showing an example of a method of driving a plurality of blocks in the fourth embodiment;

FIG. 15 is a view showing an example of dividing a pixel array in the fifth embodiment;

FIG. 16 is a view exemplarily showing the circuit arrangement of one pixel and the circuit arrangement in one column in the sixth embodiment;

FIG. 17 is a view exemplarily showing the circuit arrangement of one pixel and the circuit arrangement in one column in the sixth embodiment; and

FIG. 18 is a view showing an example of the arrangement of equipment according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

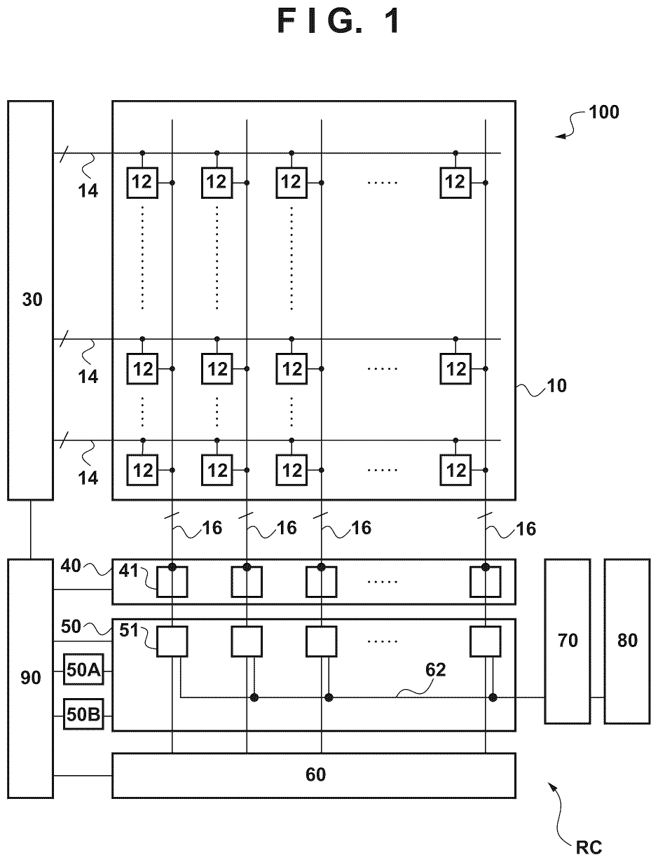

FIG. 1 is a block diagram showing an example of the arrangement of a photoelectric conversion device 100 according to the first embodiment. The photoelectric conversion device 100 can be configured as, for example, an image sensor that generates image data by capturing an optical image and outputs the image data. Alternatively, the photoelectric conversion device 100 can be configured as, for example, a sensor that generates image data by capturing an optical image and outputs information obtained by processing the image data.

The photoelectric conversion device 100 can include, for example, a pixel array 10, a vertical driving circuit 30, a driving circuit group 40, a column circuit group 50, a horizontal driving circuit 60, a signal processing circuit 70, an output circuit 80, and a system controller 90. The pixel array 10 includes a plurality of pixels 12 arranged to form a plurality of rows and a plurality of columns. The vertical driving circuit 30 functions as a controller that controls the plurality of pixels 12 divided into a plurality of blocks. As will be described later, each pixel 12 can include a photoelectric conversion element, and an in-pixel readout unit that performs an in-pixel readout operation of reading out and holding a signal from the photoelectric conversion element. The plurality of pixels 12 may include, in addition to an effective pixel that outputs a signal corresponding to the quantity of incident light, an optical black pixel where the photoelectric conversion element is shielded from light, and a dummy pixel that outputs no signal. The vertical driving circuit 30 (controller) can control the plurality of pixels 12 such that the period during which the in-pixel readout unit of each of the plurality of pixels 12 performs the readout operation is the same within each individual block and different between the plurality of blocks. The pixel array 10 may include, in addition to an effective pixel that outputs a pixel signal corresponding to the quantity of incident light, an optical black pixel where the photoelectric conversion element is shielded from light, and/or a dummy pixel that outputs no signal.

In each row of the pixel array 10, a control line group 14 can be arranged to extend in the first direction (a lateral direction in FIG. 1). The control line group 14 in each row can include a plurality of signal lines. The plurality of signal lines constituting the control line group 14 in each row can be connected to each of the multiple pixels 12 (the pixels 12 forming one row) arranged along the first direction. In other words, the plurality of signal lines constituting the control line group 14 in each row are shared by the multiple pixels 12 arranged in this row. The first direction is a direction parallel to the row (that is, row direction), and can also be referred to as a horizontal direction. The control line group 14 is connected to the vertical driving circuit 30, and driven by the vertical driving circuit 30.

In each column of the pixel array 10, a vertical output line 16 can be arranged to extend in the second direction (a longitudinal direction in FIG. 1) intersecting the first direction. The vertical output line 16 in each column can be connected to each of the multiple pixels 12 (the pixels 12 forming one column) arranged along the second direction. In other words, the vertical output line 16 in each column is shared by the multiple pixels 12 arranged in this column. The second direction is a direction parallel to the column (that is, column direction), and can also be referred to as a vertical direction. Each vertical output line 16 may be constituted by a plurality of output lines. The vertical output line 16 is connected to the driving circuit group 40.

In response to a control signal supplied from the system controller 90, the vertical driving circuit 30 generates a control signal for driving the plurality of pixels 12 constituting the pixel array 10, and supplies it to the plurality of pixels 12 via the plurality of control line groups 14. The vertical driving circuit 30 can include a shift register and/or an address decoder.

The vertical driving circuit 30 can be configured to control the plurality of pixels 12 by a partial global shutter (PGS) method. Alternatively, the vertical driving circuit 30 can have a partial global shutter mode for controlling the plurality of pixels 12 by the partial global shutter (PGS) method, and a global shutter mode for controlling the plurality of pixels 12 by a global shutter (GS) method. Mode control can be performed by, for example, a mode instruction signal to the system controller 90 from the outside. The partial global shutter (PGS) method is a method in which the plurality of pixels 12 constituting the pixel array 10 are divided into a plurality of blocks, and the pixels are driven for each block by the global shutter method. Each block can include the pixels arranged in the same row, and the pixels arranged in different rows. In other words, each block can include an arbitrary number of pixels 12 whose positions are specified by two or more rows and two or more columns. The vertical driving circuit 30 can control the plurality of pixels 12 such that the period during which the photoelectric conversion element of each of the plurality of pixels 12 constituting the pixel array 10 performs a charge accumulation operation is the same within each individual block and different between the plurality of blocks. Here, the vertical driving circuit 30 can control the plurality of pixels 12 such that the timing at which the photoelectric conversion element of each of the plurality of pixels 12 constituting the pixel array 10 starts the charge accumulation operation is the same within each individual block and different between the plurality of blocks. In addition, the vertical driving circuit 30 can control the plurality of pixels 12 such that the timing at which the photoelectric conversion element of each of the plurality of pixels 12 constituting the pixel array 10 ends the charge accumulation operation is the same within each individual block and different between the plurality of blocks.

The driving circuit group 40 includes a plurality of driving circuits 41 provided such that one driving circuit 41 corresponds to the vertical output line 16 in each column of the pixel array 10. In response to a control signal supplied from the system controller 90, each driving circuit 41 can control connection between the pixel array 10 and a corresponding column circuit 51 of the column circuit group 50 or control the potential of the vertical output line 16. The column circuit group 50 includes a plurality of column circuits 51 provided such that one column circuit 51 corresponds to the vertical output line 16 in each column of the pixel array 10.

The signal processing circuit 70 has a function of performing predetermined signal processing on the pixel signal supplied from the column circuit group 50. The signal processing circuit 70 can perform, for example, an amplification process, a correction process by Correlated Double Sampling (CDS), an analog-digital conversion (AD conversion) process, or the like. A reference signal generator 50A is connected to the plurality of column circuits 51 of the column circuit group 50. In response to a control signal output from the system controller 90, the reference signal generator 50A generates a reference signal used for AD conversion, and supplies the reference signal to the plurality of column circuits 51 of the column circuit group 50. The reference signal used for AD conversion is a signal which has a predetermined amplitude corresponding to the range of the pixel signal and whose signal level changes over time. The reference signal is not particularly limited. For example, the reference signal is a ramp signal whose signal level increases or decreases over time.

A counter circuit 50B is connected to the plurality of column circuits 51 of the column circuit group 50. In response to a control signal output from the system controller 90, the counter circuit 50B performs a count operation, and supplies a count signal having the count value generated by the count operation to the plurality of column circuits 51 of the column circuit group 50. The counter circuit 50B starts the count operation in synchronization with the start timing of a change of the signal level of the reference signal supplied from the reference signal generator 50A.

In response to a control signal supplied from the system controller 90, the horizontal driving circuit 60 generates a control signal for reading out pixel signals from the column circuit group 50, and supplies it to the plurality of column circuits 51 of the column circuit group 50. The horizontal driving circuit 60 sequentially selects the plurality of column circuits 51 of the column circuit group 50, and causes the column circuit 51 to output the pixel signal held thereby to the signal processing circuit 70. The horizontal driving circuit 60 can include a shift register and/or an address decoder or the like.

The output circuit 80 is a circuit including an external interface circuit and configured to output the signal processed by the signal processing circuit 70 to the outside of the photoelectric conversion device 100. The external interface circuit included in the output circuit 80 is not particularly limited. The external interface circuit can include, for example, a SERializer/DESerializer (SerDes) transmission circuit. The SerDes transmission circuit can include a Low Voltage Differential Signaling (LVDS) circuit or a Scalable Low Voltage Signaling (SLVS) circuit. The system controller 90 generates control signals for controlling operations of the vertical driving circuit 30, the driving circuit group 40, the column circuit group 50, the horizontal driving circuit 60, and the like. The driving circuit group 40, the column circuit group 50, the horizontal driving circuit 60, and the like form an out-of-pixel readout unit RC configured to read out signals from the pixel array 10 (pixels 12).

The control signals for controlling operations of the vertical driving circuit 30, the driving circuit group 40, the column circuit group 50, the horizontal driving circuit 60, and the like are not necessarily supplied from the system controller 90, and at least some of these may be supplied from the outside of the photoelectric conversion device 100. In FIG. 1, signal paths are illustrated below the pixel array 10. However, the present invention is not limited to this, and a circuit related to the signal path may be arranged above the pixel array 10.

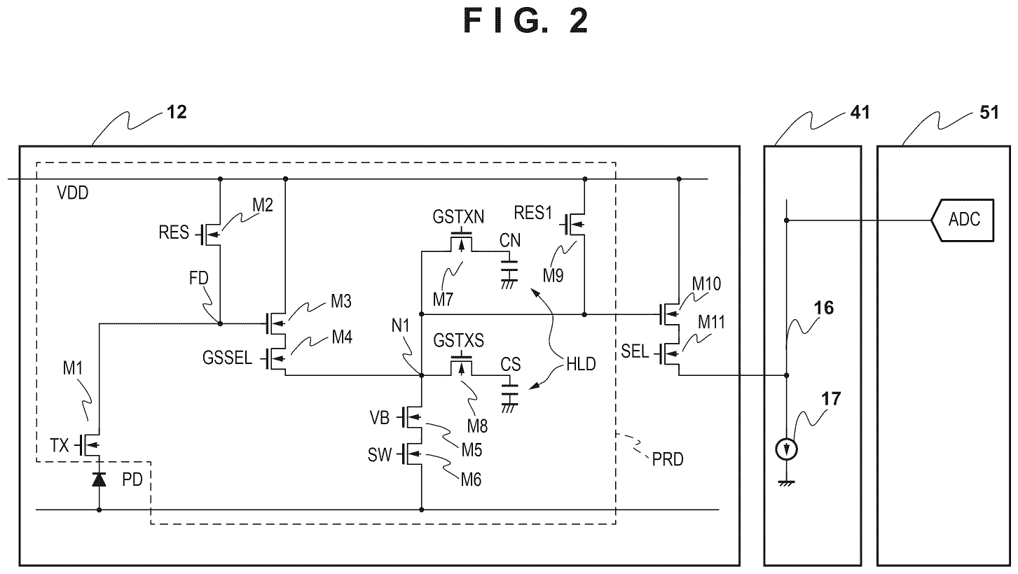

Next, with reference to FIG. 2, an example of the arrangement of the pixel 12 will be described. FIG. 2 exemplarily shows the arrangement of each pixel 12 constituting the pixel array 10. The pixel 12 can include, for example, a photoelectric conversion element PD, and an in-pixel readout unit PRD that performs an in-pixel readout operation of reading out and holding a signal from the photoelectric conversion element PD. The in-pixel readout unit PRD can include a source follower circuit. The in-pixel readout unit PRD or source follower circuit can include an amplification transistor M3, a current source M5, and a control transistor M6. The amplification transistor M3, the current source M5, and the control transistor M6 are connected in series, and the vertical driving circuit 30 (controller) switches the control transistor M6 to ON to perform the readout operation. In other words, the control transistor M6 is a transistor that controls the current source M5. The current source M5 can be formed from a transistor (MOS transistor) with a bias potential VB applied to its gate. The in-pixel readout unit PRD or source follower circuit may further include a selection transistor M4 connected in series with the amplification transistor M3, the current source M5, and the control transistor M6. Alternatively, instead of the control transistor M6, the selection transistor M4 connected in series with the amplification transistor M3 and the current source M5 may be used to control enabling and disabling of the readout operation.

The in-pixel readout unit PRD or source follower circuit can further include a charge-voltage conversion unit FD, a transfer unit M1 that transfers charges of the photoelectric conversion element PD to the charge-voltage conversion unit FD, and a reset unit M2 that resets the charge-voltage conversion unit FD. The in-pixel readout unit PRD or source follower circuit can read out a signal corresponding to the voltage of the charge-voltage conversion unit FD as the signal of the photoelectric conversion element PD, and output it to a node N1. In this embodiment, each of the transfer unit M1 and the reset unit M2 is formed from a transistor, but may be formed from another element.

The in-pixel readout unit PRD can include a first memory CN and a second memory CS. The readout operation by the in-pixel readout unit PRD can include the first operation of reading out a noise level from the photoelectric conversion element PD to the node N1 and holding it by the first memory CN, and the second operation of reading out an optical signal level from the photoelectric conversion element PD to the node N1 and holding it by the second memory CS. The in-pixel readout unit PRD can include a sample hold transistor M7 used to cause the first memory CN to hold the noise level or to read out the noise level held by the first memory CN to the node N1. The in-pixel readout unit PRD can also include a sample hold transistor M8 used to cause the second memory CS to hold the optical signal level read out to the node N1 or to read out the optical signal level held by the second memory CS to the node N1.

The pixel 12 can include an amplification transistor M10 that outputs, to the vertical output line 16, a level corresponding to each of the noise level and the optical signal level output from the first memory CN and the second memory CS, respectively, to the node N1, and a reset unit M9 that resets the node N1. The pixel 12 can also include a selection transistor M11 that connects the amplification transistor M10 to the vertical output line 16. The selection transistor M11 can also be understood as a transistor that controls an operation of outputting the signal of the pixel 12 to the vertical output line 16.

The pixel 12 may include a microlens and a color filter arranged on an optical path along which incident light is guided to the photoelectric conversion element PD. The microlens condenses incident light to the photoelectric conversion element PD. The color filter selectively transmits light of a predetermined color.

The photoelectric conversion element PD is, for example, a photodiode. The anode of the photoelectric conversion element PD can be connected to a reference voltage node, and the cathode of the photoelectric conversion element PD can be connected to the source of the transistor forming the transfer unit M1. The drain of the transistor forming the transfer unit M1 can be connected to the source of the transistor forming the reset unit M2 and the gate of the amplification transistor M3. The node to which the drain of the transistor forming the transfer unit M1, the source of the transistor forming the reset unit M2, and the gate of the amplification transistor M3 are connected can form the charge-voltage conversion unit FD, and can also be referred to as a floating diffusion. The charge-voltage conversion unit FD has a capacitance, and converts the charges generated by the photoelectric conversion element PD into a voltage. The capacitance of the charge-voltage conversion unit FD can include, for example, a p-n junction capacitance, a wiring capacitance, and the like.

Each of the drain of the transistor forming the reset unit M2 and the drain of the amplification transistor M3 can be connected to a node to which a power supply voltage (voltage VDD) is supplied. The source of the amplification transistor M3 can be connected to the drain of the selection transistor M4. The source (node N1) of the selection transistor M4 can be connected to the drain of the transistor forming the current source M5, the sources of the sample hold transistors M7 and M8, the gate of the amplification transistor M10, and the source of the transistor forming the reset unit M9.

The source of the transistor forming the current source M5 can be connected to the drain of the control transistor M6, and the source of the control transistor M6 can be connected to a ground node. The transistor forming the current source M5 supplies a bias current for driving the amplification transistor M3.

The drain of the sample hold transistor M7 can be connected to the first terminal of the first memory CN, and the drain of the sample hold transistor M8 can be connected to the first terminal of the second memory CS. The second terminal of each of the first memory CN and the second memory CS can be connected to a ground node. The drain of each of the amplification transistor M10 and the transistor forming the reset unit M9 can be connected to a node to which the voltage VDD is supplied. The source of the amplification transistor M10 can be connected to the drain of the selection transistor M11. The source of the selection transistor M11 can be connected to the vertical output line 16. The vertical output line 16 can be connected to a current source 17.

In the arrangement exemplarily shown in FIG. 2, the control line group 14 in each row includes signal lines respectively connected to the gate of the transistor forming the transfer unit M1, the gate of the transistor forming the reset unit M2, the gate of the selection transistor M4, and the gate of the control transistor M6. The control line group 14 in each row also includes signal lines respectively connected to the gates of the sample hold transistors M7 and M8, the gate of the transistor forming the reset unit M9, and the gate of the selection transistor M11.

More specifically, the gate of the transistor forming the transfer unit M1 is supplied with a control signal TX from the vertical driving circuit 30. The gate of the transistor forming the reset unit M2 is supplied with a control signal RES from the vertical driving circuit 30. The gate of the selection transistor M4 is supplied with a control signal GSSEL from the vertical driving circuit 30. The gate of the control transistor M6 is supplied with a control signal SW from the vertical driving circuit 30. The gate of the transistor forming the current source M5 is supplied with the bias voltage VB from a bias supply circuit (not shown). The gates of the sample hold transistors M7 and M8 are supplied with control signals GSTXN and GSTXS, respectively, from the vertical driving circuit 30. The gate of the transistor forming the reset unit M9 is supplied with a control signal RES1 from the vertical driving circuit 30. The gate of the selection transistor M11 is supplied with a control signal SEL from the vertical driving circuit 30.

When each transistor is formed from an n-type MOS transistor, if a control signal at high level is supplied from the vertical driving circuit 30, the corresponding transistor is switched to ON. If a control signal at low level is supplied from the vertical driving circuit 30, the corresponding transistor is switched to OFF.

Note that in this specification, a description will be given assuming a case in which, of an electron-hole pair generated by the photoelectric conversion element PD due to incident light, the electron is used as a signal charge. When using the electron as the signal charge, each transistor constituting the pixel 12 can be formed from an n-type MOS transistor. However, the signal charge is not limited to the electron, and the hole may be used as the signal charge. When using the hole as the signal charge, the conductivity type of each transistor is reversed from the conductivity type described in this embodiment.

Note that the source and drain of a MOS transistor may be changed in accordance with the conductivity type of the transistor, the function of interest, or the like. Some or all of the sources and drains used in this specification may be called by the reversed names.

The photoelectric conversion element PD converts (photoelectrically converts) incident light into charges corresponding to the quantity of the incident light, and accumulates the generated charges. If the transistor forming the transfer unit M1 is switched to ON, the charges held by the photoelectric conversion element PD are transferred to the charge-voltage conversion unit FD. The charges transferred from the photoelectric conversion element PD are held by the capacitance of the charge-voltage conversion unit FD. As a result, due to charge-voltage conversion, the charge-voltage conversion unit FD has a potential corresponding to the amount of the charges transferred from the photoelectric conversion element PD.

If the selection transistor M4 is switched to ON, the amplification transistor M3 is connected to the node N1. The amplification transistor M3 forms a source follower circuit in which the voltage VDD is supplied to the drain, the bias current is supplied to the source from the current source M5 via the selection transistor M4, and the gate serves as an input node. Accordingly, the amplification transistor M3 outputs a voltage or signal corresponding to the voltage of the charge-voltage conversion unit FD to the node N1 via the selection transistor M4. By controlling the transfer unit M1, the reset unit M2, and the selection transistor M4, it is possible to output, to the node N1, a noise level corresponding to the reset voltage of the charge-voltage conversion unit FD and an optical signal level corresponding to the quantity of incident light to the photoelectric conversion element PD.

When the noise level is output from the amplification transistor M3 to the node N1, the sample hold transistor M7 is switched to ON and the noise level is written in the first memory CN. When the optical signal level is output from the amplification transistor M3 to the node N1, the sample hold transistor M8 is switched to ON and the optical signal level is written in the second memory CS.

If the selection transistor M11 is switched to ON, the amplification transistor M10 is connected to the vertical output line 16. The amplification transistor M10 forms a source follower circuit in which the voltage VDD is supplied to the drain, the bias current is supplied to the source from the current source 17 via the selection transistor M11, and the gate serves as an input node. If the sample hold transistor M7 is switched to ON, the amplification transistor M10 outputs, to the vertical output line 16, a level corresponding to the noise level held by the first memory CN. If the sample hold transistor M8 is switched to ON, the amplification transistor M10 outputs, to the vertical output line 16, a level corresponding to the optical signal level held by the second memory CS. The amount of current flowing through the current source M5 is smaller than the amount of current flowing through the current source 17.

Furthermore, AD conversion is executed in each column circuit 51. In this manner, the sample hold transistors M7 and M8, the first memory CN, the second memory CS, the amplification transistor M10, and the selection transistor M11 function as a sample hold circuit that temporarily holds the signal output from the photoelectric conversion element PD.

If the transistor forming the reset unit M2 is switched to ON, it supplies, to the charge-voltage conversion unit FD, a voltage (a voltage corresponding to the voltage VDD) used to reset the charge-voltage conversion unit FD (voltage thereof). By simultaneously switching the transistor forming the reset unit M2 and the transistor forming the transfer unit M1 to ON, it is also possible to reset the photoelectric conversion element PD to a voltage corresponding to the voltage VDD.

In the first embodiment, each of the plurality of pixels 12 includes the first memory CN and the second memory CS. Each of the first memory CN and the second memory CS can temporarily hold a level corresponding to the charges accumulated in the photoelectric conversion element PD. This realizes a global shutter function that makes the start time and end time of a charge accumulation operation common to all pixels.

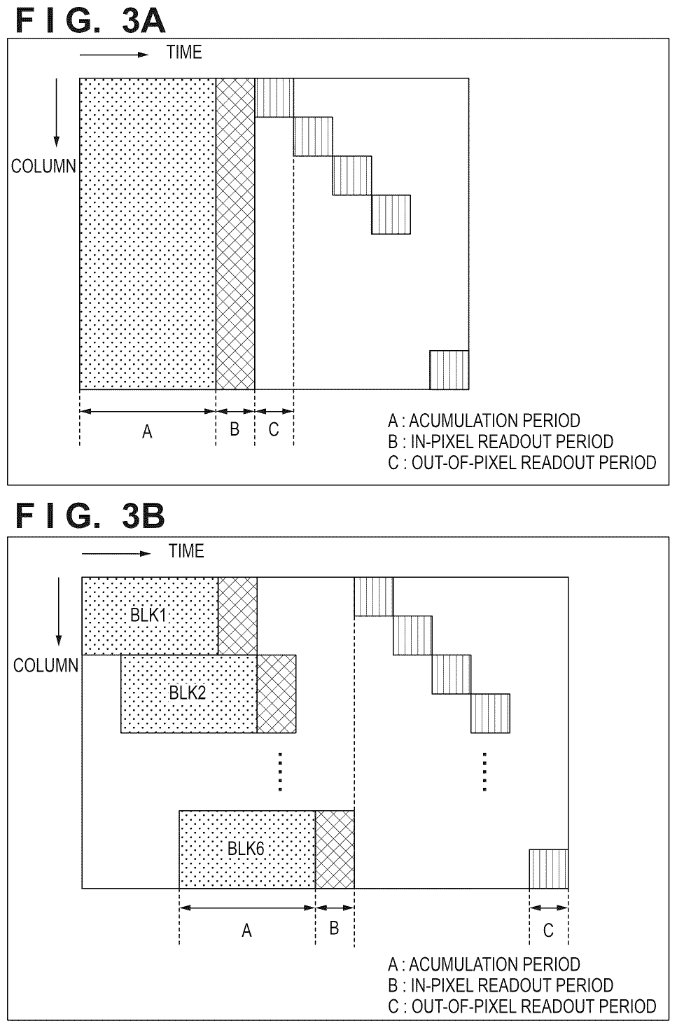

FIG. 3A schematically shows the operation of the photoelectric conversion device 100 in the global shutter (GS) mode. A period A is an accumulation period during which the photoelectric conversion element PD accumulates charges. A period B is a period during which the in-pixel readout unit PRD reads out signals (noise level and optical signal level) from the photoelectric conversion element PD and writes the signals in a holding unit HLD (first memory CN and second memory CS). The period B is referred to as an in-pixel readout period. A period C is a period during which the out-of-pixel readout unit RC reads out the signals (the signals respectively corresponding to the noise level and the optical signal level) from the pixel 12. The period C is referred to as an out-of-pixel readout period. In the global shutter mode, the operation in the period A is performed simultaneously in all pixels 12, and the operation in the period B is performed simultaneously in all pixels 12. Furthermore, in the global shutter (GS) mode, the operation in the period C is performed such that signals are sequentially read out from the pixel array 10 with one or a predetermined number of rows as a unit.

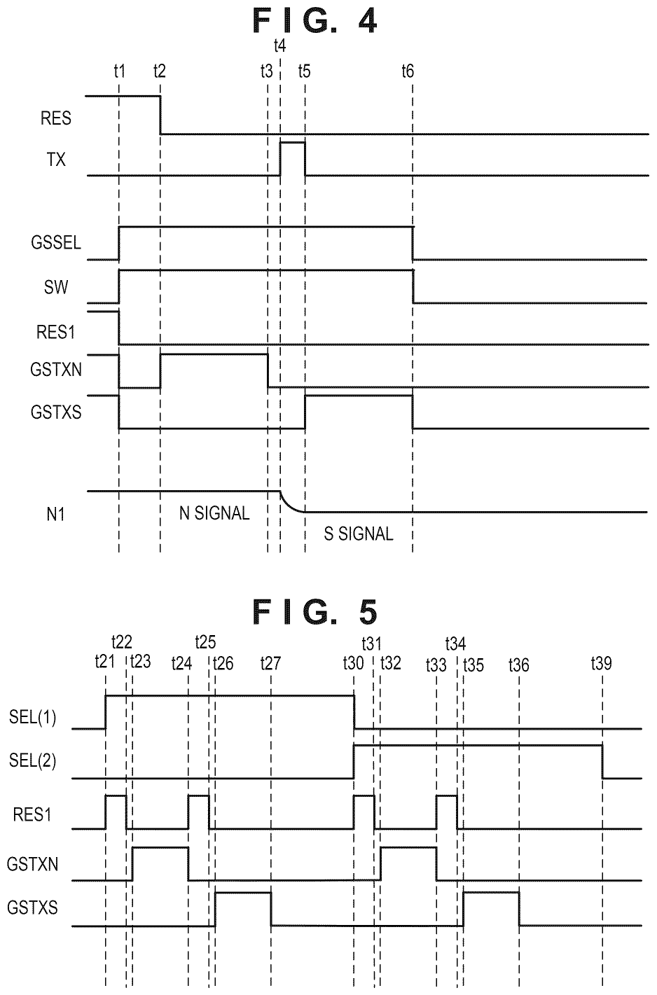

FIG. 4 exemplarily shows the in-pixel readout operation in the period B. The accumulation period is until immediately before time t1, and the period B, that is, the in-pixel readout period is from time t1 to time t6. Immediately before time t1, the control signal RES is at high level, the transistor forming the reset unit M2 is ON, and the charge-voltage conversion unit FD is set at a voltage corresponding to the voltage VDD. In addition, immediately before time t1, the control signal RES1 is at high level, the transistor forming the reset unit M9 is ON, and the node N1 is set at a voltage corresponding to the voltage VDD. Furthermore, since the control signals GSTXN and GSTXS are also at high level and the sample hold transistors M7 and M8 are ON, one end of each of the memories CN and CS is set at a voltage corresponding to the voltage VDD.

Then, at time t1, the control signal RES1 changes from high level to low level, so that the transistor forming the reset unit M9 is switched from ON to OFF. In addition, the control signals GSTXN and GSTXS change from high level to low level, so that the sample hold transistors M7 and M8 are changed from ON to OFF. That is, each of the first memory CN and the second memory CS holds the voltage immediately before time t1. Furthermore, the control signals GSSEL and SW change from low level to high level, so that the selection transistor M4 and the control transistor M6 are switched from OFF to ON. With this, a current flows through the amplification transistor M3.

Subsequently, at time t2, the control signal RES changes to low level, so that the transistor forming the reset unit M2 is switched to OFF and the reset state of the charge-voltage conversion unit FD is released. From time t2 to time t3, the control signal GSTXN is set at high level and the sample hold transistor M7 is switched to ON, so that a noise signal voltage (to be referred to as an N signal hereinafter) corresponding to the noise level is written in the first memory CN. Then, at time t3, the control signal GSTXN changes from high level to low level, and the sample hold transistor M7 changes from ON to OFF. With this, the first memory CN is set in a hold state.

Then, from time t4 to time t5, the control signal TX is set at high level, the transistor forming the transfer unit M1 is switched to ON, and charges in the photoelectric conversion element PD are transferred to the charge-voltage conversion unit FD. From time t5 to time t6, the control signal GSTXS is set at high level. With this, the sample hold transistor M8 is switched to ON, and an optical signal voltage (to be referred to as an S signal hereinafter) corresponding to the optical signal level corresponding to the amount of charges of the photoelectric conversion element PD is written in the second memory CS.

Then, at time t6, the control signal GSTXS changes from high level to low level, and the sample hold transistor M8 changes from ON to OFF. With this, the second memory CS is set in a hold state. In this manner, in each pixel 12, the N signal and the S signal are held by the first memory CN and the second memory CS, respectively. Thereafter, when the control signals GSSEL and SW are set at low level, current supply by the current source M5 is stopped.

FIG. 5 exemplarily shows the operation (out-of-pixel readout operation) in the period C. The period B ends by time t21. The readout period (one horizontal scanning period) of signals from the pixels 12 in the first row is from time t21 to time t30. FIG. 5 shows the readout periods of signals from the pixels 12 in the first row and the second row.

At time t21, the selection signal SEL(1) (the number in parentheses indicates the row number) for the first row changes from low level to high level. At this time, the current source 17 is ON. Note that the timing for the current source 17 to change to ON is not limited to this example, and the current source 17 may be ON before time t21. Since the current source 17 is ON, a current flows through the amplification transistor M10, so that the signal can be read out from the pixel 12.

Then, in the period from time t21 to time t22, the control signal RES1 is set at high level, and the node N1 is set to a voltage corresponding to the voltage VDD. Note that the node N1 may be set to another reference voltage. Thereafter, in the period from time t23 to time t24, the control signal GSTXN is set at high level, and the sample hold transistor M7 is switched to ON. Accordingly, the N signal held by the first memory CN is set to the gate of the amplification transistor M10. With this, a signal corresponding to the N signal is supplied to the column circuit 51 via the selection transistor M11 and the vertical output line 16, and AD conversion is executed.

Sequentially, from time t24 to time t25, the control signal RES1 is set at high level, and the node N1 is set (initialized) to the voltage corresponding to the voltage VDD again. This operation can reduce the influence of the state before reading out the signal from the selected memory on the signal read out from the selected memory.

In the period from time t26 to time t27, the control signal GSTXS is set at high level, and the sample hold transistor M8 is switched to ON. Accordingly, the S signal held by the second memory CS is set to the gate of the amplification transistor M10. With this, a signal corresponding to the S signal is supplied to the column circuit 51 from the vertical output line 16 via the selection transistor M11, and AD conversion is executed.

At time t30, the selection signal SEL(1) changes from high level to low level, and the selection transistor M11 is switched from ON to OFF. On the other hand, the selection signal SEL(2) changes from low level to high level, and the readout operation of the signal from the pixel 12 in the second row is started. In this manner, signals can be read out from all pixels 12 and AD-converted. Note that at the timing when the readout operations of the signals from all pixels 12 end, the current source 17 may be changed from ON to OFF.

In the global shutter (GS) mode as described above, since the current sources M5 of all pixels 12 operate at the same time, the peak value of current consumption in the overall pixel array 10 can be significantly large. Accordingly, the value of current supplied by the current source M5 may become lower than the design value, or the power supply voltage may drop, and this can cause a degradation in image quality. Therefore, the partial global shutter (PGS) mode as described below is advantageous.

FIG. 3B schematically shows the operation of the photoelectric conversion device 100 in the partial global shutter (PGS) mode. As an example of dividing the plurality of pixels 12 constituting the pixel array 10 into a plurality of blocks, FIG. 3B shows an example of dividing them into six blocks BLK1 to BLK6. First, the period A (accumulation period) will be described. In the partial global shutter (PGS) mode, the period A (accumulation period) is decided for each block. In the example shown in FIG. 3B, six periods A (accumulation periods) respectively corresponding to six blocks BLK1 to BLK6 are decided. The vertical driving circuit 30 (controller) controls the plurality of pixels 12 such that the period during which each of the plurality of pixels 12 performs the accumulation operation is the same within each individual block and different between the plurality of blocks. Here, the vertical driving circuit 30 controls the plurality of pixels 12 such that the timing at which each of the plurality of pixels 12 starts the accumulation operation is the same within each individual block and different between the plurality of blocks. In addition, the vertical driving circuit 30 controls the plurality of pixels 12 such that the timing at which each of the plurality of pixels 12 ends the accumulation operation is the same within each individual block and different between the plurality of blocks. On the other hand, the vertical driving circuit 30 controls the plurality of pixels 12 such that the length of the period of the accumulation operation in each of the plurality of pixels 12 is the same in all blocks, in other words, the same in all pixels 12.

Next, the period B (in-pixel readout period) will also be described. The vertical driving circuit 30 (controller) controls the plurality of pixels 12 such that the period during which the in-pixel readout unit PRD of each of the plurality of pixels 12 performs the readout operation is the same within each individual block and different between the plurality of blocks. Here, the vertical driving circuit 30 controls the plurality of pixels 12 such that the timing at which the in-pixel readout unit PRD of each of the plurality of pixels 12 starts the readout operation is the same within each individual block and different between the plurality of blocks. In addition, the vertical driving circuit 30 controls the plurality of pixels 12 such that the timing at which the in-pixel readout unit PRD of each of the plurality of pixels 12 ends the readout operation is the same within each individual block and different between the plurality of blocks. On the other hand, the vertical driving circuit 30 controls the plurality of pixels 12 such that the length of the period B (in-pixel readout period) is the same in all blocks, in other words, the same in all pixels 12.

Next, the period C (out-of-pixel readout period) will also be described. The period C (out-of-pixel readout period) in the partial global shutter (PGS) mode is similar to the period C (out-of-pixel readout period) in the global shutter (GS) mode.

In the example shown in FIG. 3B, the out-of-pixel readout unit RC starts to read out signals from the plurality of pixels 12 after the accumulation period ends in all of the plurality of pixels 12. Such a configuration is advantageous in suppressing the peak value of current consumption in the photoelectric conversion device 100. However, the out-of-pixel readout unit RC may start to read out signals from the plurality of pixels 12 before the accumulation period ends in all of the plurality of pixels 12.

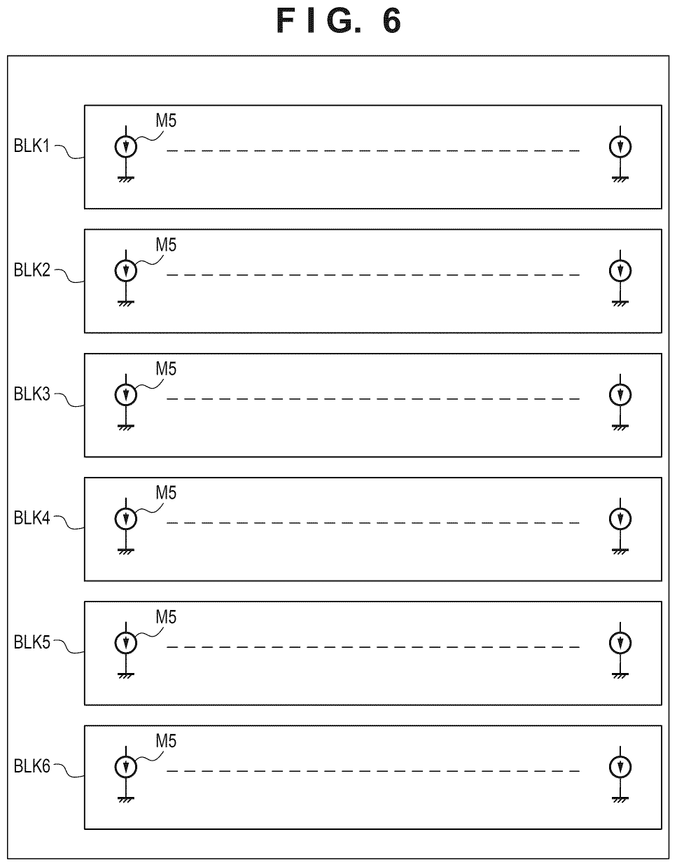

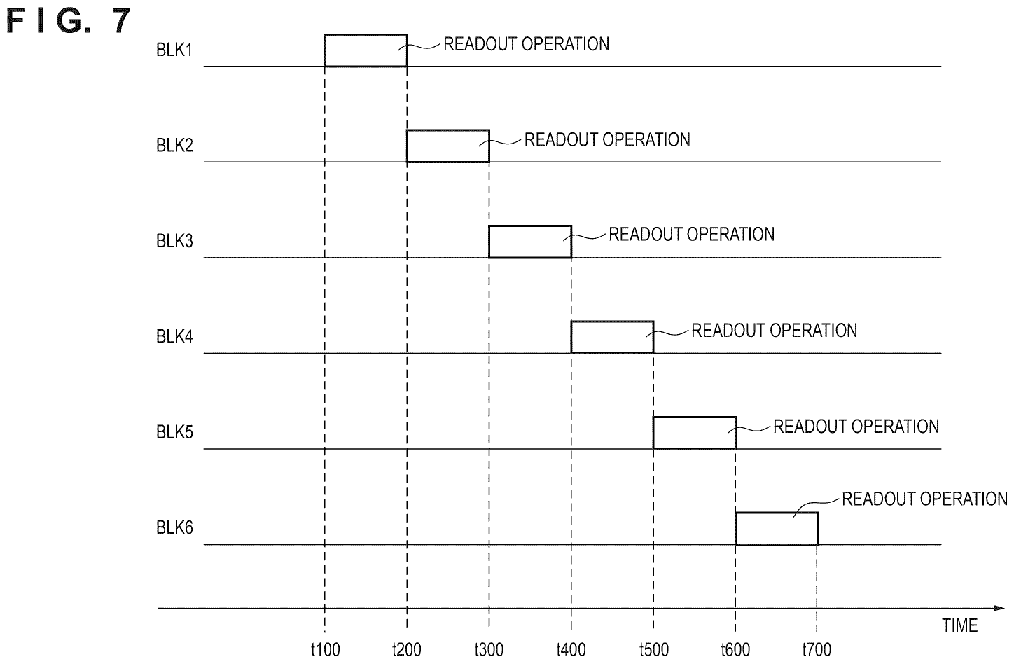

FIG. 6 schematically shows an example in which, as exemplarily described with reference to FIG. 3B, the pixel array 10 (the plurality of pixels 12 constituting the pixel array 10) is divided into the plurality of blocks BLK1 to BLK6 in the vertical direction. FIG. 7 schematically shows the in-pixel readout operations in the plurality of blocks BLK1 to BLK6. In FIG. 7, “readout operation” means the in-pixel readout operation. In FIG. 7, the abscissa represents time. The period from time t100 to time t200 corresponds to the period B and the period from time t1 to time t6 in FIG. 4 for the block BLK1. In the period from time t100 to time t200, the current sources M5 of all of the pixels 12 in the block BLK1 are set in an active state and the in-pixel readout operation is performed. With this, in all of the pixels 12 in the block BLK1, the noise level and the optical signal level are written in the first memory CN and the second memory CS, respectively. The period from time t200 to time t300 corresponds to the period B and the period from time t1 to time t6 in FIG. 4 for the block BLK2. In the period from time t200 to time t300, the current sources M5 of all of the pixels 12 in the block BLK2 are set in an active state and the in-pixel readout operation is performed. With this, in all of the pixels 12 in the block BLK2, the noise level and the optical signal level are written in the first memory CN and the second memory CS, respectively.

Similarly, the period from time t300 to time t400 corresponds to the period B and the period from time t1 to time t6 in FIG. 4 for the block BLK3, and the period from time t400 to time t500 corresponds to the period B and the period from time t1 to time t6 in FIG. 4 for the block BLK4. The period from time t500 to time t600 corresponds to the period B and the period from time t1 to time t6 in FIG. 4 for the block BLK5, and the period from time t600 to time t700 corresponds to the period B and the period from time t1 to time t6 in FIG. 4 for the block BLK6.

As described above, in the first embodiment, the vertical driving circuit 30 (controller) controls the plurality of pixels 12 such that the period during which the in-pixel readout unit PRD of each of the plurality of pixels 12 performs the in-pixel readout operation is the same within each individual block and different between the plurality of blocks. In another viewpoint, the vertical driving circuit 30 (controller) divides the plurality of pixels 12 constituting the pixel array 10 into a plurality of blocks, drives the pixels 12 in each individual block in the same period, and drives the pixels 12 belonging to different blocks in different periods. With this, while suppressing the peak value of current consumption, image distortion within the block can be eliminated, thereby reducing distortion in the entire image.

In the example described above, the pixel array (the plurality of pixels constituting the pixel array) is divided into six blocks, but the present invention is not limited to this. In addition, the number of the vertical output lines 16 and the number of column circuits (for example, the AD conversion circuits or the like) may be decided in accordance with the number of pixels constituting each block.

Furthermore, in the example described above, one pixel 12 includes one photoelectric conversion element PD, but one pixel 12 may include a plurality of photoelectric conversion elements PD. The plurality of photoelectric conversion elements PD included in one pixel 12 may share one charge-voltage conversion unit FD. The pixel 12 may include a photoelectric conversion element for focus detection, or may include an element for changing the gain. In this case, the circuit arrangement for reading out signals can be changed, as appropriate.

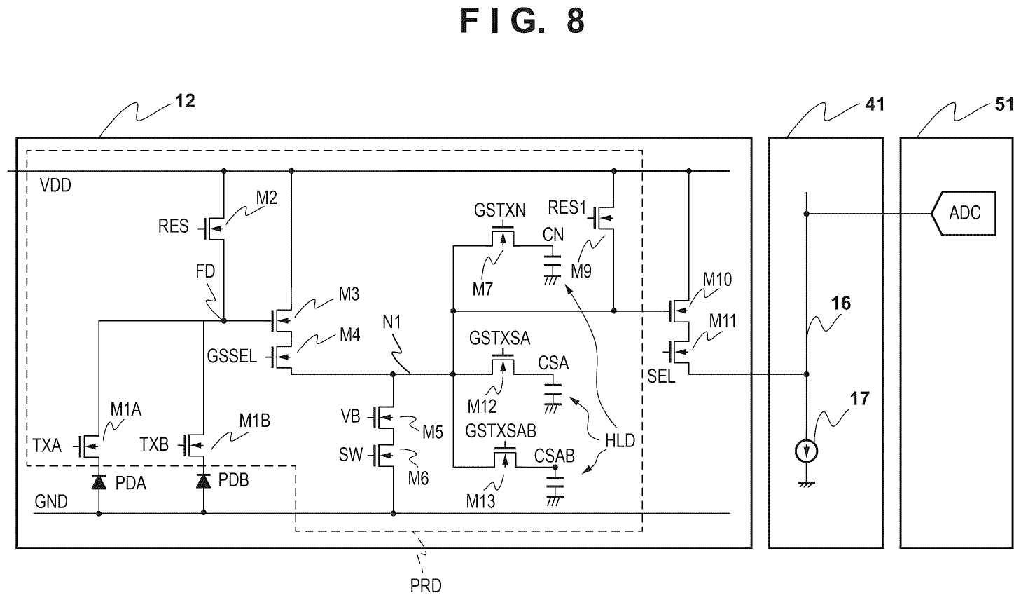

For example, FIG. 8 shows a modification of the photoelectric conversion device 100 according to the first embodiment. In this modification, each pixel 12 includes two photoelectric conversion elements PDA and PDB. Matters not mentioned for the modification shown in FIG. 8 can follow the above description.

In the modification shown in FIG. 8, each pixel 12 includes two transfer units M1A and M1B. The transfer units M1A and M1B can be formed from transistors, and control signals TXA and TXB can be supplied to the gates thereof, respectively, from the vertical driving circuit 30. Each pixel 12 can also include sample hold transistors M7, M12, and M13, and memories CN, CSA, and CSAB corresponding to them. The source of each of the sample hold transistors M7, M12, and M13 can be connected to the node N1. The second terminal of each of the memories CN, CSA, and CSAB can be connected to the ground node. The gates of the sample hold transistors M7, M12, and M13 can be supplied with control signals GSTXN, GSTXSA, and GSTXSAB, respectively, from the vertical driving circuit 30.

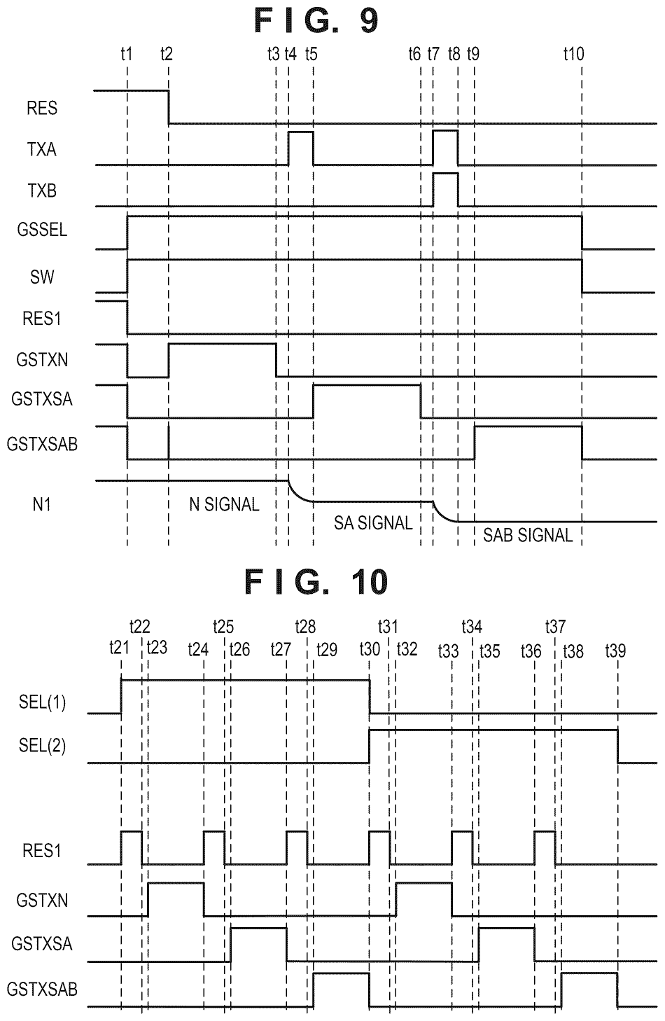

FIG. 9 exemplarily shows the in-pixel readout operation in the period B of the modification shown in FIG. 8. Matters not mentioned here can follow the above description. The accumulation period is until immediately before time t1, and the period B, that is, the in-pixel readout period is from time t1 to time t10. Immediately before time t1, the control signal RES is at high level, the transistor forming the reset unit M2 is ON, and the charge-voltage conversion unit FD is set at a voltage corresponding to the voltage VDD. In addition, immediately before time t1, the control signal RES1 is at high level, the transistor forming the reset unit M9 is ON, and the node N1 is set at a voltage corresponding to the voltage VDD. Furthermore, since the control signals GSTXN, GSTXSA, and GSTXSAB are also at high level and the sample hold transistors M7, M12, and M13 are ON, one end of each of the memories CN, CSA, and CSAB is set at a voltage corresponding to the voltage VDD.

The operation in the period from time t1 to time t3 is similar to that in the example shown in FIG. 4. Then, from time t4 to time t5, the control signal TXA is set at high level, the transistor forming the transfer unit MIA is switched to ON, and charges in the photoelectric conversion element PDA are transferred to the charge-voltage conversion unit FD. From time t5 to time t6, the control signal GSTXSA is set at high level. With this, the sample hold transistor M12 is switched to ON, and the first image signal voltage (to be referred to as an SA signal hereinafter) corresponding to the charges of the photoelectric conversion element PDA is written in the memory CSA. Then, at time t6, the control signal GSTXSA changes from high level to low level, and the sample hold transistor M12 changes from ON to OFF. With this, the memory CSA is set in a hold state.

In the period from time t7 to time t8, the control signals TXA and TXB are set at high level, and the transistors respectively forming the transfer units MIA and MIB are switched to ON. With this, charges in the photoelectric conversion elements PDA and PDB are transferred to the charge-voltage conversion unit FD. That is, in the charge-voltage conversion unit FD, charges of the photoelectric conversion element PDB are added to charges of the photoelectric conversion element PDA. At this time, whether to transfer charges of the photoelectric conversion element PDA to the charge-voltage conversion unit FD again by the control signal TXA can be selected, as appropriate.

In the period from time t9 to time t10, the control signal GSTXSAB is set at high level. With this, the sample hold transistor M13 is switched to ON, and the second image signal voltage (to be referred to as an SAB signal hereinafter) corresponding to the charges of the photoelectric conversion elements PDA and PDB is written in the memory CSAB. Then, at time t10, the control signal GSTXSAB changes from high level to low level, and the sample hold transistor M13 changes from ON to OFF. With this, the memory CSAB is set in a hold state.

In this manner, in each pixel 12, the N signal, the SA signal, and the SAB signal are held by the memories CN, CSA, and CSAB, respectively. Thereafter, when the control signal GSSEL and the control signal SW are set at low level, current supply by the current source M5 is stopped.

FIG. 10 exemplarily shows the operation (out-of-pixel readout operation) in the period C of the modification shown in FIG. 8. Matters not mentioned here can follow the above description. The period B ends by time t21. In the period from time t26 to time t27, the control signal GSTXSA is set at high level, and the sample hold transistor M12 is switched to ON. Accordingly, the SA signal held by the memory CSA is set to the gate of the amplification transistor M10. With this, a signal corresponding to the SA signal is supplied to the column circuit 51 via the selection transistor M11 and the vertical output line 16, and AD conversion is executed.

Furthermore, from time t27 to time t28, the control signal RES1 is switched from low level to high level again, and the node N1 is set (initialized) to the voltage corresponding to the voltage VDD again.

In the period from time t29 to time t30, the control signal GSTXSAB is set at high level, and the sample hold transistor M13 is switched to ON. Accordingly, the SAB signal held by the memory CSAB is set to the gate of the amplification transistor M10. With this, a signal corresponding to the SAB signal is supplied to the column circuit 51 from the vertical output line 16 via the selection transistor M11, and AD conversion is executed. The operation from time t30 is similar to that in the example shown in FIG. 5.

In the pixel 12, a larger number of photoelectric conversion elements may share one charge-voltage conversion unit FD. The pixel 12 may also include an element for changing the gain. In this case, the circuit arrangement for reading out signals can be changed, as appropriate. The arrangement of memories for holding signals and the arrangement of current sources can also be changed, as appropriate.

The pixel 12 may have an AD conversion function and, for example, the arrangement described in International Publication No. 2016/009832 can be applied thereto. Also in this case, by setting the timing at which the in-pixel readout unit of each of the plurality of pixels starts the in-pixel readout operation to be the same within each individual block and different between the plurality of blocks, it is possible to suppress the peak value of current consumption.

In this embodiment, the current source M5 (first current source) is configured or controlled to supply the first current to the amplification transistor M3. The current source 17 (second current source) is configured or controlled to supply the second current to the amplification transistor M10. Here, the first current (magnitude thereof) is preferably smaller than the second current (magnitude thereof). It is preferable that the first current (magnitude thereof) satisfies at least one of the following conditions: less than 90%, less than 80%, less than 70%, less than 60%, less than 50%, less than 40%, less than 30%, less than 20%, and less than 10% of the second current (magnitude thereof). Alternatively, it is preferable that the first current (magnitude thereof) satisfies at least one of the following conditions: less than ½, less than ¼, less than ⅛, less than 1/16, less than 1/32, less than 1/64, less than 1/128, less than 1/256, and less than 1/512 of the second current (magnitude thereof).

The advantages of making the first current (magnitude thereof) smaller than the second current (magnitude thereof) will be described below. One amplification transistor M3, to which one current source M5 supplies the first current, writes a signal in only one of the memories CN, CA, and CAB at a time. Therefore, the current (magnitude thereof) required for one current source M5 is relatively small.

On the other hand, one amplification transistor M10, to which the current source 17 supplies the second current, needs to drive the load (capacitance) of the vertical output line 16 extending in the column direction and the multiple selection transistors M11 connected thereto. Therefore, the current (magnitude thereof) required for one current source 17 is relatively large. Hence, the first current (magnitude thereof) may be smaller than the second current (magnitude thereof). In the global shutter mode, the current sources M5 of the plurality of pixels 12 constituting the pixel array 10 operate simultaneously in the in-pixel readout period as the period B. Therefore, making the first current (magnitude thereof) smaller than the second current (magnitude thereof) is useful for suppressing the peak value of current consumption. By suppressing the peak value of current consumption, the power supply potential and the ground potential can be stabilized, and this is advantageous in reducing noise. In addition, suppressing the peak value of current consumption is also advantageous in reducing the amount of power consumption.

### Second Embodiment

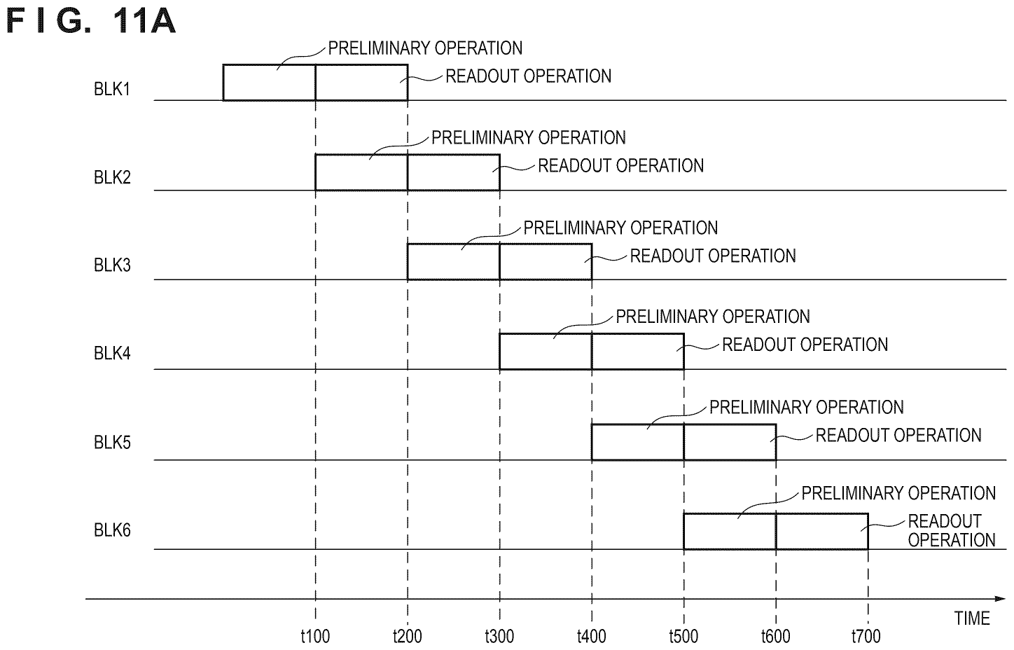

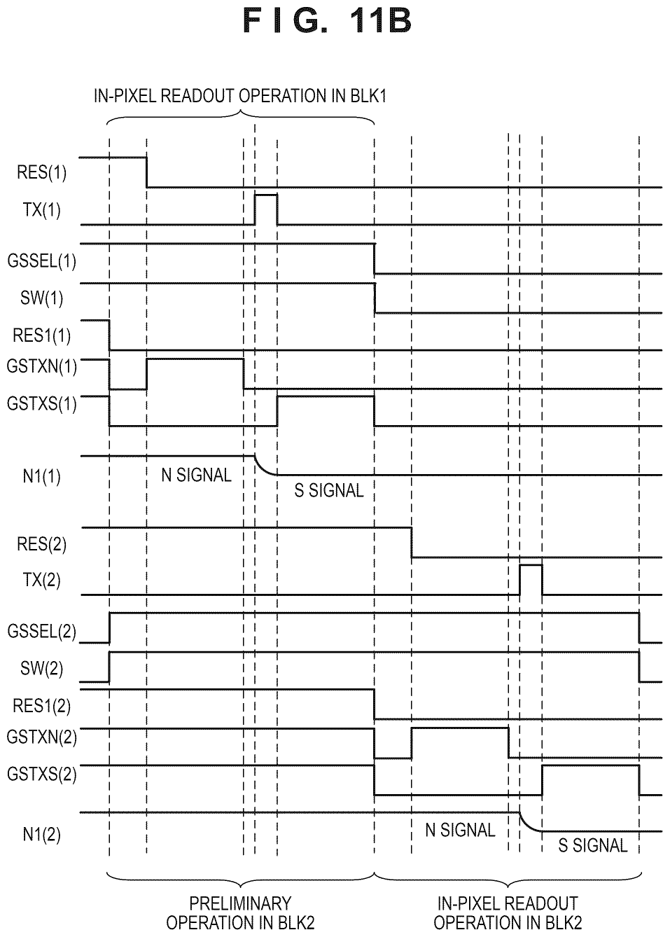

With reference to FIGS. 11A and 11B, the second embodiment will be described below. FIG. 11B shows an example of the detailed operation in the period from time t100 to time t300 in FIG. 11A. Matters not mentioned in the second embodiment can follow the first embodiment.

In the second embodiment, a vertical driving circuit 30 (controller) controls a plurality of pixels 12 so as to execute a preliminary operation prior to an in-pixel readout operation. At this time, the vertical driving circuit 30 controls execution of the preliminary operation with each block of a plurality of blocks BLK1 to BLK6 as a unit. The preliminary operation includes an operation of setting a control transistor M6 in an ON state while causing a reset unit M2 to reset a charge-voltage conversion unit FD.

The vertical driving circuit 30 can control the plurality of pixels 12 such that, in at least a part of the period during which the in-pixel readout operation is performed in one block of the plurality of blocks, the preliminary operation is performed in another block of the plurality of blocks where the in-pixel readout operation is to be performed next. Alternatively, the vertical driving circuit 30 can control the plurality of pixels 12 such that, in the period during which the in-pixel readout operation is performed in one block of the plurality of blocks, the preliminary operation is performed in another block of the plurality of blocks where the in-pixel readout operation is to be performed next. Alternatively, the vertical driving circuit 30 can control the plurality of pixels 12 such that, in the whole period during which the in-pixel readout operation is performed in one block of the plurality of blocks, the preliminary operation is performed in another block of the plurality of blocks where the in-pixel readout operation is to be performed next.

By performing the preliminary operation prior to the in-pixel readout operation as described above, the operation of a current source M5 of an in-pixel readout unit PRD can be stabilized before the start of the in-pixel readout operation. This can improve image quality. The value of current flowing from the current source M5 in the preliminary operation may be the same as the value of current flowing from the current source M5 in the in-pixel readout operation, but is preferably smaller than the value of current flowing from the current source M5 in the in-pixel readout operation. Alternatively, the amount of current flowing from the current source M5 in the preliminary operation may be the same as the amount of current flowing from the current source M5 in the in-pixel readout operation, but is preferably smaller than the amount of current flowing from the current source M5 in the in-pixel readout operation.

Here, in a predetermined period (from time t100 to time t200), the plurality of blocks can include the first block (BLK1) that is controlled as a block to perform the in-pixel readout operation by the vertical driving circuit 30 (controller), the second block (BLK2) that is controlled as a block to perform the in-pixel readout operation by the vertical driving circuit 30 in a period (for example, from time t200 to time t300) after the predetermined period, and the third block (BLK3) different from the first block and the second block. In the predetermined period, the amount of current flowing through the current source M5 in third block (BLK3) is preferably smaller than the amount of current flowing through the current source M5 in the first block (BLK1) and the amount of current flowing through the current source M5 in the second block (BLK2). In the predetermined period, the amount of current flowing through the current source M5 in the second block (BLK2) is preferably equal to or smaller than the amount of current flowing through the current source M5 in the first block (BLK1).

In the first period (before time t100) before the predetermined period, the amount of current flowing through the current source M5 in the first block (BLK1) is preferably larger than the amount of current flowing through the current source M5 in the second block (BLK2).

The amount of current flowing through the current source M5 in the first block (BLK1) in the first period is preferably smaller than the amount of current flowing through the current source M5 in the first block (BLK1) in the predetermined period.

### Third Embodiment

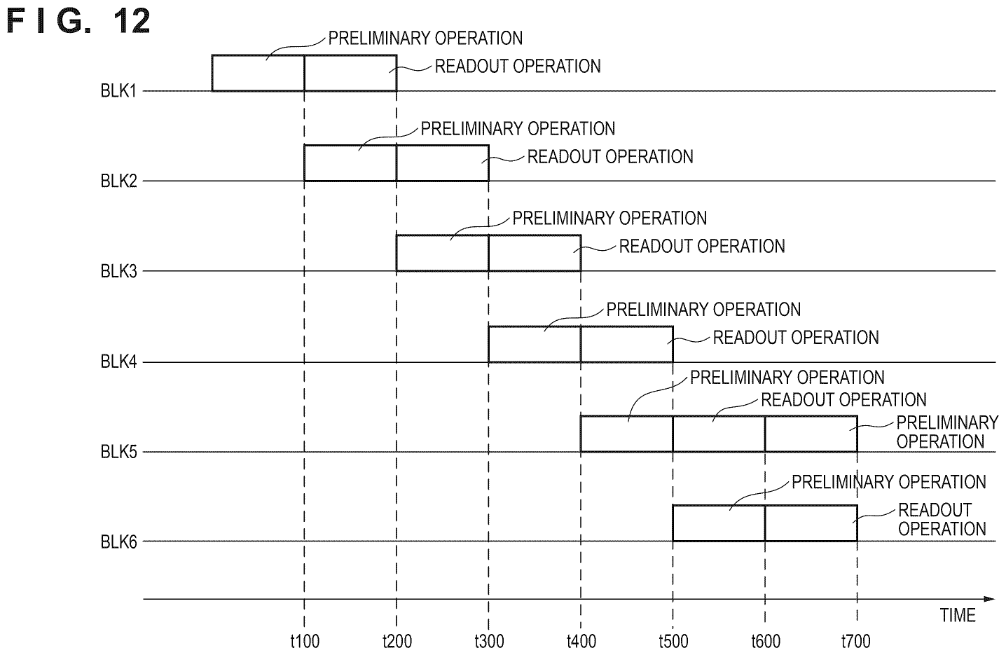

With reference to FIG. 11B in addition to FIG. 12, the third embodiment will be described below. FIG. 11B incorporated in the third embodiment shows an example of the detailed operation in the period from time t100 to time t300 in FIG. 12. The third embodiment is a modification of the second embodiment, and matters not mentioned in the third embodiment can follow the second embodiment.

A vertical driving circuit 30 can control a plurality of pixels 12 such that, in a period for performing an in-pixel readout operation in the block where the in-pixel readout operation is performed last among a plurality of blocks BLK1 to BLK6, a preliminary operation is performed in another block. In another viewpoint, the vertical driving circuit 30 can control the plurality of pixels 12 such that the number of blocks to simultaneously perform the preliminary operation is kept constant. In the example shown in FIG. 12, the vertical driving circuit 30 controls the plurality of pixels 12 such that the number of blocks to simultaneously perform the preliminary operation is kept constant at one.

According to the third embodiment, fluctuation of current consumption in a period during which an in-pixel readout circuit PRD performs the in-pixel readout operation is suppressed, and image quality can be improved.

### Fourth Embodiment

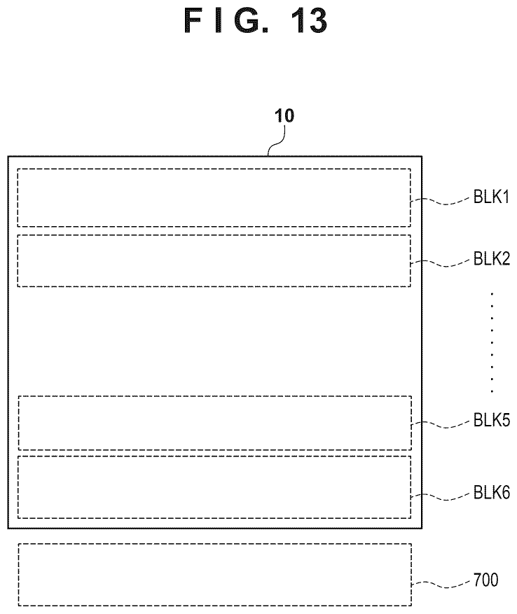

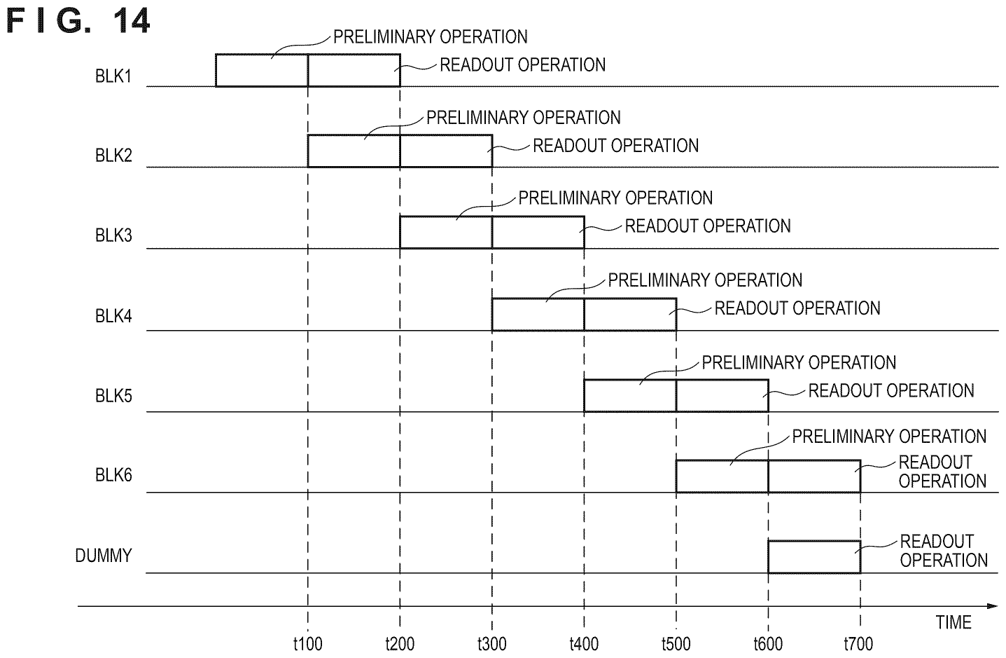

With reference to FIG. 11B in addition to FIGS. 13 and 14, the fourth embodiment will be described below. FIG. 11B incorporated in the fourth embodiment shows an example of the detailed operation in the period from time t100 to time t300 in FIG. 14. The fourth embodiment is a modification of the second or third embodiment, and matters not mentioned in the fourth embodiment can follow the second or third embodiment.

A photoelectric conversion device 100 according to the fourth embodiment includes a dummy current source 700. A vertical driving circuit 30 can operate the dummy current source 700 in the period from time t600 to time t700 during which an in-pixel readout operation is performed in a block BLK6 where the in-pixel readout operation is performed last among a plurality of blocks BLK1 to BLK6.

The value of current flowing from the dummy current source 700 may be the same as the value of current flowing from a current source M5 in the in-pixel readout operation, or may be different from the value of current flowing from the current source M5 in the in-pixel readout operation, but is preferably equal to the value of current flowing from the current source M5 in a preliminary operation.

### Fifth Embodiment

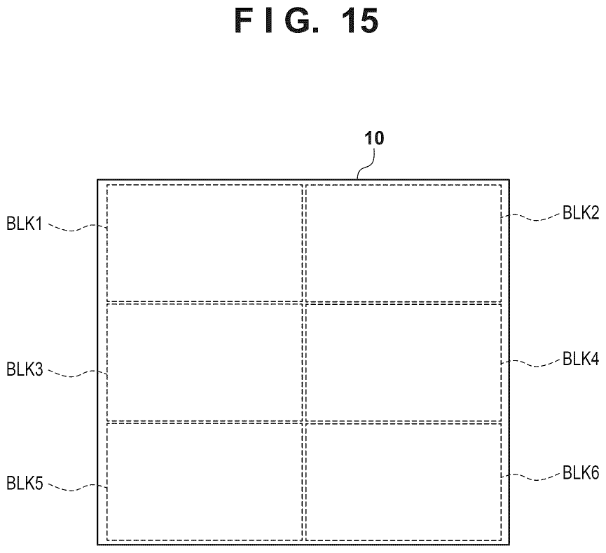

With reference to FIG. 15, the fifth embodiment will be described below. Matters not mentioned in the fifth embodiment can follow the first to fourth embodiments. The fifth embodiment relates to a method of dividing a pixel array 10 (a plurality of pixels 12 constituting the pixel array 10).

A plurality of blocks BLK1 to BLK6 constituting the pixel array 10 can be arranged to form a plurality of block rows and a plurality of block columns, as exemplarily shown in FIG. 15. The block row is a row formed by two or more blocks, and the block column is a column formed by two or more blocks. A vertical driving circuit 30 supplies a control signal group to the blocks belonging to the same block row via different control line groups 14. The vertical driving circuit 30 can be configured to drive the plurality of blocks BLK1 to BLK6 constituting the pixel array 10 in a predetermined order.

### Sixth Embodiment

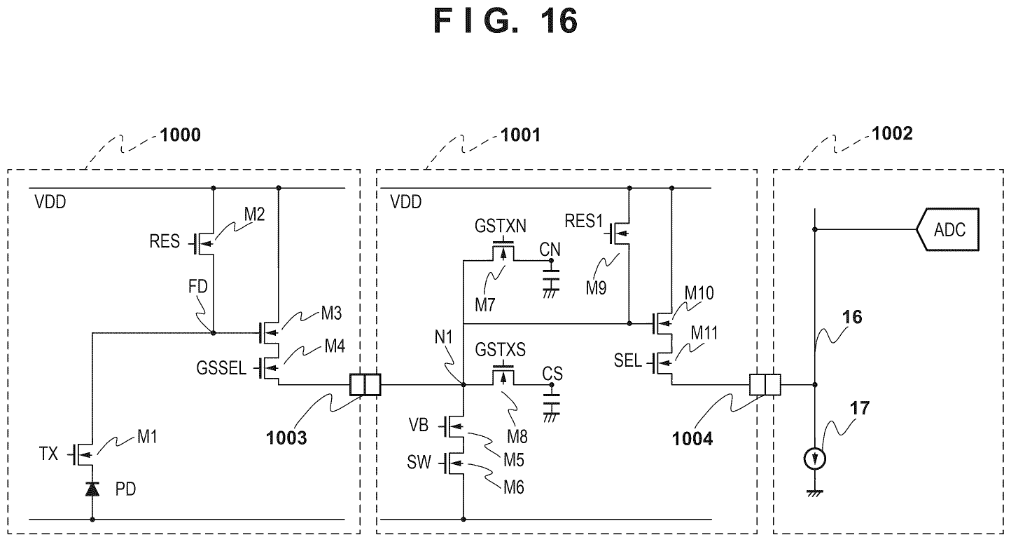

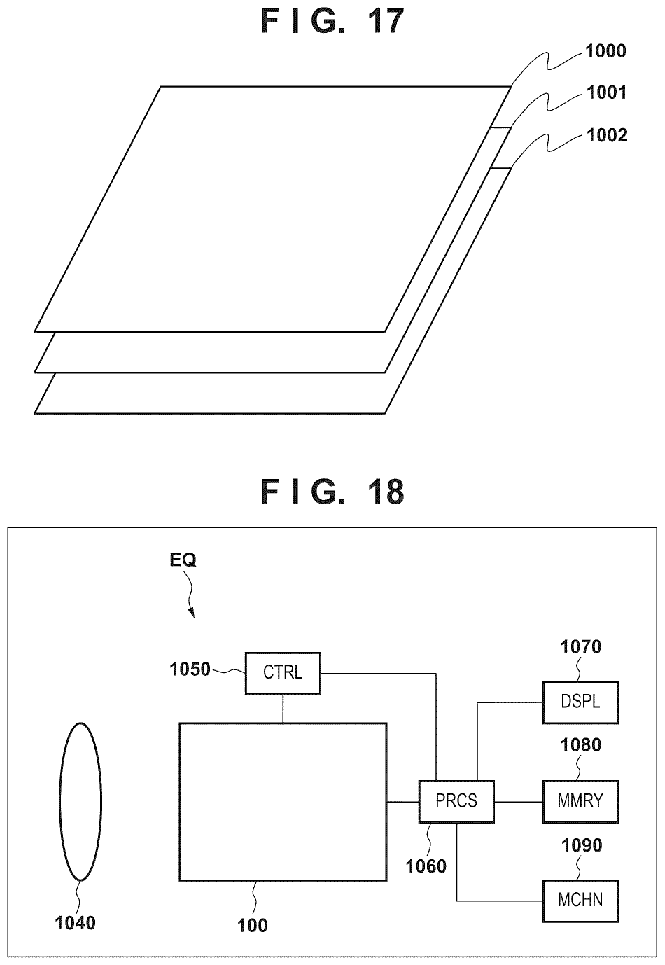

With reference to FIGS. 16 and 17, the sixth embodiment will be described below. Matters not mentioned in the sixth embodiment can follow the first to fifth embodiments. In the sixth embodiment, a photoelectric conversion device 100 can be formed from a stacked substrate where a plurality of substrates 1000, 1001, and 1002 are stacked. Each of the plurality of substrates includes a semiconductor layer.

In an example, at least a part of an out-of-pixel readout unit RC, which can be formed from a driving circuit group 40, a column circuit group 50, a horizontal driving circuit 60, and the like, can be arranged on the substrate 1002 (third substrate) different from the substrate 1000 (first substrate) or the substrate 1001 (second substrate) where a plurality of pixels 12 are arranged. For example, the out-of-pixel readout unit RC (the driving circuit group 40, the column circuit group 50, and the horizontal driving circuit 60), a signal processing circuit 70, an output circuit 80, and a system controller 90 can be arranged on the substrate 1002.

The components of the plurality of pixels 12 can be arranged on two or more substrates 1000 and 1001. In the example shown in FIG. 16, a photoelectric conversion element PD, a transfer unit M1, a reset unit M2, an amplification transistor M3, and a selection transistor M4 are arranged on the first substrate 1000. On the second substrate 1001, a current source M5, a control transistor M6, memories CN and CS, sample hold transistors M7 and M8, an amplification transistor M10, a selection transistor M11, and a reset unit M9 are arranged. On the third substrate 1002, a vertical output line 16, a current source 17, an AD conversion circuit, and subsequent circuits are arranged. Here, the connection structures between the substrates indicated by connection portions 1003 and 1004 are not particularly limited. Further, elements and combinations thereof arranged on each substrate are not limited to this example. For example, the arrangement as shown in FIG. 8 in which one pixel includes a plurality of photoelectric conversion elements is applicable. By employing the stacked substrate, the area efficiency is improved, which relaxes constraints on the element arrangement and simplifies the element size and the circuit arrangement. Furthermore, degradation of image quality can be reduced by reducing crosstalk or the like.

### Application Example

One application example of the photoelectric conversion device 100 is an image capturing device that generates an image (image data) by capturing an optical image. Other application examples of the photoelectric conversion device are a distance measurement device (a device for focus detection, distance measurement using Time Of Flight (TOF), or the like) and a light measurement device (a device for measuring the incident light amount or the like).

With reference to FIG. 18, equipment EQ incorporating the photoelectric conversion device 100 will be described below. The equipment EQ can include at least one of the photoelectric conversion device 100 configured as an image sensor, an optical device 1040, a control device 1050, a processing device 1060, a display device 1070, a storage device 1080, and a mechanical device 1090. The optical device 1040 is implemented by, for example, a lens, a shutter, and a mirror. The control device 1050 controls a semiconductor chip 210. The control device 1050 is, for example, a semiconductor device such as an ASIC.

The processing device 1060 processes a signal output from the semiconductor chip 210. The processing device 1060 is a semiconductor device such as a CPU or an ASIC for forming an Analog Front End (AFE) or a Digital Front End (DFE). The display device 1070 is an EL display device or a liquid crystal display device that displays information (an image) obtained by the semiconductor chip 210. The storage device 1080 is a magnetic device or a semiconductor device that stores the information (an image) obtained by the semiconductor chip 210. The storage device 1080 is a volatile memory such as an SRAM or a DRAM, or a nonvolatile memory such as a flash memory or a hard disk drive.

The mechanical device 1090 includes a moving or propulsion unit such as a motor or an engine. In the equipment EQ, the signal output from the semiconductor chip 210 is displayed on the display device 1070 or transmitted to an external device by a communication device (not shown) included in the equipment EQ. Hence, the equipment EQ may further include the storage device 1080 and the processing device 1060 in addition to the memory circuits and arithmetic circuits included in the semiconductor chip 210. The mechanical device 1090 may be controlled based on the signal output from the semiconductor chip 210.

In addition, the equipment EQ is suitable for electronic equipment such as an information terminal (for example, a smartphone or a wearable terminal) which has a shooting function or a camera (for example, an interchangeable lens camera, a compact camera, a video camera, or a monitoring camera). The mechanical device 1090 in the camera can drive the components of the optical device 1040 in order to perform zooming, an in-focus operation, and a shutter operation. Alternatively, the mechanical device 1090 in the camera can move the semiconductor chip 210 in order to perform an anti-vibration operation.

Furthermore, the equipment EQ can be transportation equipment such as a vehicle, a ship, or an airplane. The mechanical device 1090 in the transportation equipment can be used as a moving device. The equipment EQ as the transportation equipment is suitable for equipment that transports the semiconductor chip 210 or equipment that uses a shooting function to assist and/or automate driving (steering). The processing device 1060 for assisting and/or automating driving (steering) can perform, based on the information obtained by the semiconductor chip 210, processing for operating the mechanical device 1090 as a moving device. Alternatively, the equipment EQ may be medical equipment such as an endoscope, measurement equipment such as a distance measurement sensor, analysis equipment such as an electron microscope, office equipment such as a copy machine, or industrial equipment such as a robot.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-065615, filed Apr. 15, 2024 and Japanese Patent Application No. 2024-122556, filed Jul. 29, 2024, which are hereby incorporated by reference herein in their entirety.

What is claimed is:

1. A photoelectric conversion device that includes a plurality of pixels arranged to form a plurality of rows and a plurality of columns, the device comprising
a controller configured to control the plurality of pixels divided into a plurality of blocks,
wherein
each of the plurality of blocks includes pixels arranged in the same row and pixels arranged in different rows,
each pixel includes a photoelectric conversion element, and an in-pixel readout unit configured to perform an in-pixel readout operation of reading out and holding a signal from the photoelectric conversion element,
the in-pixel readout unit includes a source follower circuit including an amplification transistor and a current source,
the controller controls the plurality of pixels such that a period during which the in-pixel readout unit of each of the plurality of pixels performs the in-pixel readout operation is the same within each individual block and different between the plurality of blocks,
the plurality of blocks include
a first block that is controlled as a block to perform the in-pixel readout operation by the controller in a predetermined period,
a second block that is controlled as a block to perform the in-pixel readout operation by the controller in a period after the predetermined period, and
a third block different from the first block and the second block,
in the predetermined period, an amount of current flowing through the current source in the third block is smaller than an amount of current flowing through the current source in the first block and an amount of current flowing through the current source in the second block, and
in the predetermined period, an amount of current flowing through the current source in the second block is not more than an amount of current flowing through the current source in the first block.

2. The device according to claim 1, wherein
in a first period before the predetermined period, an amount of current flowing through the current source in the first block is larger than an amount of current flowing through the current source in the second block.

3. The device according to claim 2, wherein
an amount of current flowing through the current source in the first block in the first period is smaller than an amount of current flowing through the current source in the first block in the predetermined period.

4. The device according to claim 1, wherein
the controller controls the plurality of pixels such that a timing at which the in-pixel readout unit of each of the plurality of pixels starts the in-pixel readout operation is the same within each individual block and different between the plurality of blocks.

5. The device according to claim 1, wherein
the source follower circuit further includes a control transistor, and the amplification transistor, the current source, and the control transistor are connected in series, and
the controller switches the control transistor to ON to perform the in-pixel readout operation.

6. The device according to claim 5, wherein
the in-pixel readout unit further includes a charge-voltage conversion unit, a transfer unit configured to transfer a charge of the photoelectric conversion element to the charge-voltage conversion unit, and a reset unit configured to reset the charge-voltage conversion unit, and the source follower circuit reads out a signal corresponding to a voltage of the charge-voltage conversion unit as a signal of the photoelectric conversion element.

7. The device according to claim 6, wherein
the in-pixel readout operation includes a first operation of reading out a noise level from the photoelectric conversion element, and a second operation of reading out an optical signal level corresponding to incident light from the photoelectric conversion element, and
the in-pixel readout unit includes a first memory configured to hold the noise level, and a second memory configured to hold the optical signal level.

8. The device according to claim 7, wherein
the controller controls the plurality of pixels so as to execute a preliminary operation prior to the in-pixel readout operation,
the controller controls execution of the preliminary operation with each block of the plurality of blocks as a unit, and
the preliminary operation includes an operation of setting the control transistor in an ON state while causing the reset unit to reset the charge-voltage conversion unit.

9. The device according to claim 8, wherein
the controller controls the plurality of pixels such that, in a period during which the in-pixel readout operation is performed in one block of the plurality of blocks, the preliminary operation is performed in another block of the plurality of blocks where the in-pixel readout operation is to be performed next.

10. The device according to claim 9, wherein
the controller controls the plurality of pixels such that, in a period for performing the in-pixel readout operation in a block where the in-pixel readout operation is performed last among the plurality of blocks, the preliminary operation is performed in another block.

11. The device according to claim 9, wherein
the controller controls the plurality of pixels such that the number of blocks to simultaneously perform the preliminary operation is kept constant.

12. The device according to claim 9, further comprising a dummy current source,
wherein the controller operates the dummy current source in a period during which the in-pixel readout operation is performed in a block where the in-pixel readout operation is performed last among the plurality of blocks.

13. The device according to claim 1, wherein
the controller controls the plurality of pixels such that a period during which the photoelectric conversion element of each of the plurality of pixels performs a charge accumulation operation is the same within each individual block and different between the plurality of blocks.

14. The device according to claim 13, wherein
the controller controls the plurality of pixels such that a timing at which the photoelectric conversion element of each of the plurality of pixels starts the charge accumulation operation is the same within each individual block and different between the plurality of blocks.

15. The device according to claim 14, further comprising an out-of-pixel readout unit configured to read out signals from the plurality of pixels,
wherein the out-of-pixel readout unit starts to read out signals from the plurality of pixels after the in-pixel readout operation ends in all of the plurality of pixels.

16. The device according to claim 1, wherein
the source follower circuit further includes a selection transistor arranged between the amplification transistor and the current source.

17. The device according to claim 1, wherein
the plurality of blocks are arranged to form a plurality of block rows and a plurality of block columns.

18. The device according to claim 1, further comprising an out-of-pixel readout unit configured to read out signals from the plurality of pixels,
wherein at least a part of the out-of-pixel readout unit is arranged on a third substrate different from one of a first substrate and a second substrate where the plurality of pixels are arranged.

19. The device according to claim 1, wherein
components of the plurality of pixels are arranged on not less than two substrates.

20. Equipment comprising:
a photoelectric conversion device defined in claim 1; and
a processing device configured to process a signal output from the photoelectric conversion device.
